(19) United States
(12) Patent Application Publication
(10) Pub. No.: US 2026/0285354 A1
(43) Pub. Date: Sep. 24, 2026

(54) IN-VEHICLE SYSTEM AND STORAGE MEDIUM

(71) Applicant: SONY HONDA MOBILITY INC., Tokyo (JP)

(72) Inventors: Junichi NAGAHARA, Tokyo (JP); Yukinori Taniuchi, Tokyo (JP); Shuichi Ono, Tokyo (JP); Yasuhisa Ito, Tokyo (JP); Toshihiro Hirao, Tokyo (JP)

(73) Assignee: SONY HONDA MOBILITY INC., Tokyo (JP)

(21) Appl. No.: 19/087,629

(22) Filed: Mar. 24, 2025

(51) Int. Cl. B60W 50/16; G06F 3/16

(52) U.S. Cl. CPC B60W 50/16; G06F 3/165; B60W 2520/105; B60W 2520/125; B60W 2540/10

(57) ABSTRACT

To enable a sense of stability of a vehicle when a change in a travel state is minute to be produced. An in-vehicle system according to an aspect of the present technique acquires travel information indicating a travel state of a vehicle and starts output of a plurality of types of sounds with different frequency ranges that constitute a pseudo powertrain sound during acceleration and deceleration at different timings according to a change in the travel state. The present technique can be applied to electric vehicles including a function to output pseudo powertrain sounds.

### BACKGROUND OF THE INVENTION

### Field of the Invention

The present technique relates to an in-vehicle system and a storage medium and, particularly, to an in-vehicle system and a storage medium that enable a sense of stability of a vehicle to be produced when a change in a travel state is minute.

### Description of the Related Art

In electric vehicles that produce no engine sound while traveling, there are techniques to generate a pseudo engine sound based on accelerator position, velocity, and the like. Generating a pseudo engine sound and outputting the pseudo engine sound toward the inside of a vehicle enables a sensation similar to that of driving a vehicle mounted with an engine to be imparted to the driver. For example, during acceleration and deceleration (acceleration/deceleration), a pseudo engine sound is outputted at a volume according to a degree of acceleration and deceleration (see, for example, Japanese Laid-Open Patent Publication No. 2000-1142 A, International Publication No. WO 2011/092833 A1, and U.S. Pat. No. 11,919,446 B2).

The volume of the pseudo engine sound tends to decrease when the degree of acceleration and deceleration is minute due to reasons such as those described below.
Reason 1: Giving variety to the loudness of volume increases a sense of coherence with driving operations.
Reason 2: A general generated sound is constituted of a repetition of sounds with a certain pattern. Since continued output of such a sound causes annoyance to a driver, volume tends to be suppressed when the degree of acceleration and deceleration is minute.

When the volume of the pseudo engine sound is low, depending on the volume of ambient sound, the pseudo engine sound may seem interrupted. Interruption of the pseudo engine sound due to noise during driving or the like imparts an unstable feeling to the driver with respect to behavior of the vehicle.

The present technique has been devised in consideration of such circumstances and an object thereof is to enable a sense of stability of a vehicle to be produced when a change in a travel state is minute.

Note that the description of the problem given above does not preclude the existence of other problems.

### SUMMARY OF THE INVENTION

An in-vehicle system according to an aspect of the present technique includes: an acquiring unit that acquires travel information indicating a travel state of a vehicle; and an acoustic control unit that starts output of a plurality of types of sounds with different frequency ranges that constitute a pseudo powertrain sound during acceleration and deceleration at different timings according to a change in the travel state.

In the aspect of the present technique, travel information indicating a travel state of a vehicle is acquired, and output of a plurality of types of sounds with different frequency ranges that constitute a pseudo powertrain sound during acceleration and deceleration is started at different timings according to a change in the travel state.

According to the present technique, a sense of stability of a vehicle when a change in a travel state is minute can be produced.

### BRIEF DESCRIPTION OF THE DRAWINGS

FIG. 1 is a diagram showing an example of output of a pseudo powertrain sound during deceleration;

FIG. 2 is a block diagram showing a configuration example of an acoustic control unit;

FIG. 3 is a diagram showing an example of acoustic parameters of a pseudo powertrain sound;

FIG. 4 is a block diagram showing a configuration example of an in-vehicle system;

FIG. 5 is a block diagram showing a functional configuration example of the in-vehicle system; and

FIG. 6 is a flow chart showing an example of processing during deceleration of the in-vehicle system.

### DETAILED DESCRIPTION OF THE INVENTION

Hereinafter, a mode for carrying out the present technique will be described. The description will be given in the following order.
1. Outline of present technique
2. Example of output control of pseudo powertrain sound
3. Configuration example of in-vehicle system
4. Operation of in-vehicle system
5. Modifications

### Outline of Present Technique

The present technique relates to a technique of generating and outputting, as a pseudo powertrain sound to be outputted inside a vehicle, a sound that includes a sound that produces a sense of stability of the vehicle and a sound that produces a travel state. For example, the travel state includes a motor torque during deceleration and a velocity during acceleration.

The pseudo powertrain sound generated by an in-vehicle system is outputted toward, for example, a driver from speakers provided in the vehicle. The present technique is applied to, for example, electric vehicles. A driver of an electric vehicle mounted with the in-vehicle system according to an embodiment of the present technique is to drive while listening to the pseudo powertrain sound constituted of a plurality of types of sounds during acceleration and deceleration.

The pseudo powertrain sound is a produced sound that simulates the sound of a powertrain such as an engine or a motor. The pseudo powertrain sound may contain various sounds used for production during travel such as a brake noise or a wind noise.

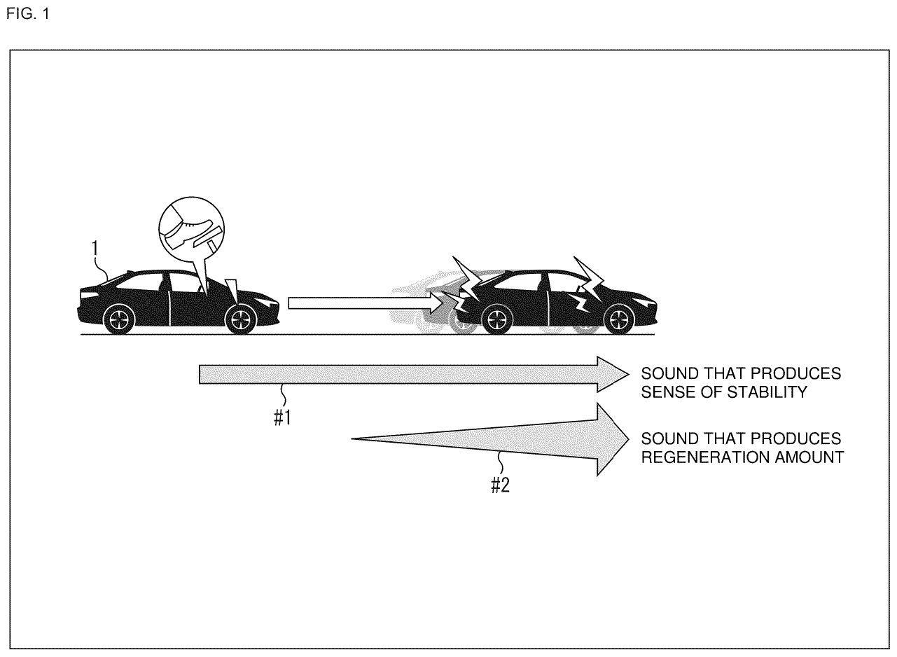

FIG. 1 is a diagram showing an example of output of a pseudo powertrain sound during deceleration.

When a deceleration operation of a vehicle 1 is performed by stepping on a brake pedal or the like, output of a pseudo powertrain sound including a sound that produces a regeneration amount is performed. The vehicle 1 that is an electric vehicle is provided with a regenerative function that converts kinetic energy generated during deceleration into electric power and charges a battery.

As shown in FIG. 1, the pseudo powertrain sound during deceleration is constituted of two types of sounds: a sound that produces a sense of stability and a sound that produces a regeneration amount. Each sound has a different frequency. For example, a sound in a low-frequency range is used as the sound that produces a sense of stability and a sound in a high-frequency range is used as the sound that produces a regeneration amount. For example, the sound that produces a sense of stability and the sound that produces a regeneration amount are sounds of which major tones are separated by two or more octaves (four or more times a frequency ratio). Sounds of which major tones are separated by two or more octaves are used because, when frequencies of the major tones of the sound that produces a sense of stability and the sound that produces a regeneration amount are close to each other, the tones sound as though they change discontinuously when an operation amount is increased and the sense of coherence with the travel state decreases.

Hereinafter, when appropriate, the sound that produces a sense of stability will be referred to as a Sense-of-stability-producing sound and the sound that produces a regeneration amount will be referred to as a regeneration amount-producing sound. When the sense-of-stability-producing sound is assumed to be a low-frequency sound part (first sound) of the pseudo powertrain sound, the regeneration amount-producing sound is assumed to be a high-frequency sound part (second sound) of the pseudo powertrain sound.

As indicated by an arrow #1 in FIG. 1, output of the sense-of-stability-producing sound is started immediately after a deceleration operation is performed. A small threshold is used as a threshold that defines an output timing of the sense-of-stability-producing sound. The output of the sense-of-stability-producing sound is started at a timing where a deceleration operation has been performed and a minute regeneration is detected.

On the other hand, as indicated by an arrow #2, output of the regeneration amount-producing sound is started after the output of the sense-of-stability-producing sound. A threshold that is larger than the threshold of the sense-of-stability-producing sound is used as a threshold that defines an output timing of the regeneration amount-producing sound. The output of the regeneration amount-producing sound is started after the deceleration operation has been continued and at a timing where a regeneration of a certain level or higher is detected. The level of regeneration is represented by, for example, a motor torque.

In this manner, the output of the sense-of-stability-producing sound as a low-frequency sound part that constitutes the pseudo powertrain sound is started when there is a change in motor torque of a smaller amount of change than an amount of change that defines the output timing of the high-frequency sound part. While the output of the sense-of-stability-producing sound starts at a timing immediately after the deceleration operation, the output of the regeneration amount-producing sound is to start at a timing later than the output timing of the sense-of-stability-producing sound.

After the output of the regeneration amount-producing sound is started, the outputs of the sense-of-stability-producing sound and the regeneration amount-producing sound are continued until the deceleration ends. The respective acoustic parameters of the sense-of-stability-producing sound and the regeneration amount-producing sound change in real time according to the degree of deceleration. The acoustic parameters include a parameter that indicates a volume and a parameter that indicates a pitch. The gradual widening of the right side of the arrow #2 in FIG. 1 indicates that the amount of change in the acoustic parameters of the regeneration amount-producing sound is larger than the amount of change in the acoustic parameters of the sense-of-stability-producing sound.

Since the output of the sense-of-stability-producing sound to constitute a low-frequency sound part is started immediately after a deceleration operation, the fact that deceleration is being performed can be presented to the driver immediately after the deceleration operation. If only the regeneration amount-producing sound were to be output, the output of the regeneration amount-producing sound would only start at a delayed timing from the start of the deceleration operation, which may impart an unstable feeling to the driver with respect to the behavior of the vehicle. However, such a situation can be prevented.

A sound in the low-frequency range is less likely to be affected by ambient sound than a sound in the high-frequency range. Since the sense-of-stability-producing sound that is a sound in the low-frequency range is continuously outputted, even when the volume of the ambient sound is high, the pseudo powertrain sound during deceleration can be prevented from being heard intermittently.

In addition, the fact that the regenerative function is operating can be presented to the driver by the regeneration amount-producing sound to constitute a high-frequency sound part. The output of the regeneration amount-producing sound can be started according to whether or not an actually-detected regeneration amount has exceeded a threshold.

### Example of output control of pseudo powertrain sound

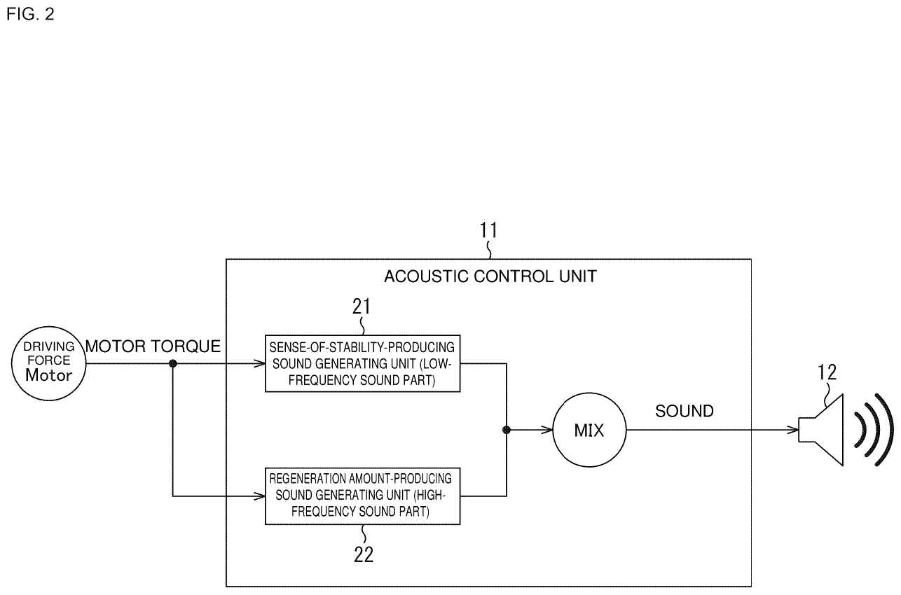

FIG. 2 is a Block Diagram Showing a Configuration example of an acoustic control unit. An acoustic control unit 11 shown in FIG. 2 is provided in the in-vehicle system according to an embodiment of the present technique. FIG. 2 shows a configuration related to output of the pseudo powertrain sound during deceleration.

The acoustic control unit 11 is configured to include a sense-of-stability-producing sound generating unit 21 and a regeneration amount-producing sound generating unit 22. Information indicating a torque of a motor that generates a drive force of the vehicle 1 is inputted to the sense-of-stability-producing sound generating unit 21 and the regeneration amount-producing sound generating unit 22.

The sense-of-stability-producing sound generating unit 21 generates the sense-of-stability-producing sound to be the low-frequency sound part of the pseudo powertrain sound based on the motor torque and outputs data of the sense-of-stability-producing sound.

The regeneration amount-producing sound generating unit 22 generates the regeneration amount-producing sound to be the high-frequency sound part of the pseudo powertrain sound based on the motor torque and outputs data of the regeneration amount-producing sound.

Data outputted from the sense-of-stability-producing sound generating unit 21 and data outputted from the regeneration amount-producing sound generating unit 22 are combined to generate data of the pseudo powertrain sound. Based on the combined data, the pseudo powertrain sound is outputted from a speaker 12 provided in the vehicle.

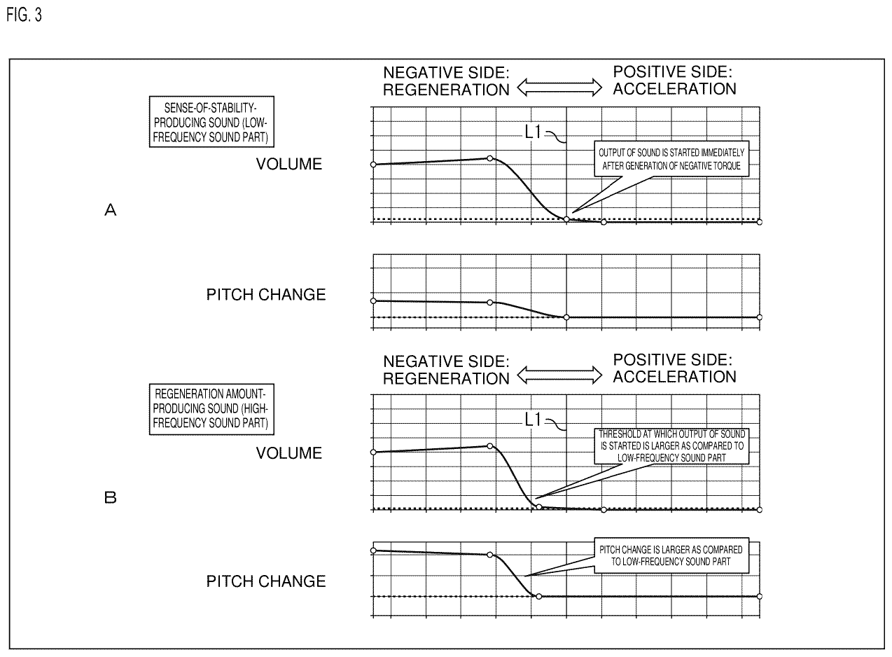

FIG. 3 is a diagram showing an example of acoustic parameters of a pseudo powertrain sound. A in FIG. 3 shows acoustic parameters of a sense-of-stability-producing sound and B in FIG. 3 shows acoustic parameters of a regeneration amount-producing sound.

A and B in FIG. 3 show a graph of volume and pitch change. A lateral direction in each graph represents motor torque. A right side of a straight line L1 represents torque in a positive direction (acceleration) while a left side represents torque in a negative direction (regeneration).

As shown in upper halves of A and B in FIG. 3, respectively, a threshold torque at which the output of the sense-of-stability-producing sound is started using a predetermined volume is smaller than a threshold torque at which the output of the regeneration amount-producing sound is started. The output of the sense-of-stability-producing sound is started immediately after a torque in the negative direction is generated.

In the example shown in FIG. 3, maximum volumes of the sense-of-stability-producing sound and the regeneration amount-producing sound are set to roughly the same volume. Since the threshold of the regeneration amount-producing sound is higher than the threshold of the sense-of-stability-producing sound, a change in volume of the regeneration amount-producing sound is steeper than a change in volume of the sense-of-stability-producing sound.

As shown in lower halves of A and B in FIG. 3, respectively, a threshold torque at which a pitch change of the sense-of-stability-producing sound starts is smaller than a threshold torque at which a pitch change of the regeneration amount-producing sound starts. The pitch change of the sense-of-stability-producing sound starts immediately after a torque in the negative direction is generated.

In the example shown in FIG. 3, a maximum pitch change of the regeneration amount-producing sound is set to a larger change than a maximum pitch change of the sense-of-stability-producing sound. The pitch change of the regeneration amount-producing sound is to be a change that is steeper and larger than the pitch change of the sense-of-stability-producing sound.

Using such acoustic parameters enables the fact that output of the sense-of-stability-producing sound is started immediately after a deceleration operation and that deceleration is being performed to be presented to the driver immediately after the deceleration operation. Accordingly, an unstable feeling with respect to the behavior of the vehicle can be prevented from being imparted to the driver. In addition, the fact that the regenerative function is operating can be presented in an effective manner to the driver by the regeneration amount-producing sound which changes steeply and largely.

An output of the pseudo powertrain sound during acceleration is performed in a similar manner. Specifically, the pseudo powertrain sound during acceleration is constituted of a sense-of-stability-producing sound that is a sound that produces a sense of stability and a sense-of-acceleration-producing sound that is a sound that produces a sense of acceleration. Each sound has a different frequency. For example, a sound in a low-frequency range is used as the sense-of-stability-producing sound and a sound in a high-frequency range is used as the sense-of-acceleration-producing sound. The sense-of-stability-producing sound is to constitute a low-frequency sound part of the pseudo powertrain sound and the sense-of-acceleration-producing sound is to constitute a high-frequency sound part of the pseudo powertrain sound.

Output of the sense-of-stability-producing sound is started immediately after an acceleration operation is performed by stepping on a gas pedal or the like. A small threshold is used as a threshold that defines an output timing of the sense-of-stability-producing sound. The output of the sense-of-stability-producing sound is started at a timing where an acceleration operation has been performed and a minute acceleration is detected.

On the other hand, output of the sense-of-acceleration-producing sound is started after the output of the sense-of-stability-producing sound. A threshold that is larger than the threshold of the sense-of-stability-producing sound is used as a threshold that defines an output timing of the sense-of-acceleration-producing sound. The output of the sense-of-acceleration-producing sound is started after the acceleration operation has been continued and at a timing where an acceleration of a certain level or higher is detected. The level of acceleration is represented by, for example, an accelerator position.

Since the output of the sense-of-stability-producing sound to constitute a low-frequency sound part is started immediately after an acceleration operation, the fact that acceleration is being performed can be presented to the driver immediately after the acceleration operation. Accordingly, an unstable feeling with respect to the behavior of the vehicle can be prevented from being imparted to the driver.

It is also possible to have a sound constituted of three or more types of sounds used as the pseudo powertrain sound. In addition, various types of information regarding the travel state such as an accelerator position and a vehicle speed can be used to control the output of the pseudo powertrain sound.

### Configuration Example of In-Vehicle System

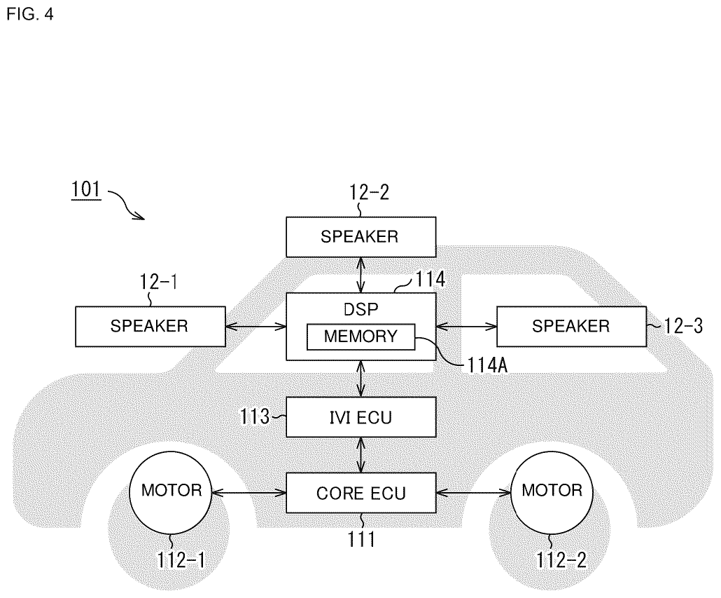

FIG. 4 is a block diagram showing a configuration example of an in-vehicle system 101 to be mounted to the vehicle 1.

The in-vehicle system 101 is configured to include a CORE ECU 111, motors 112-1 and 112-2, an IVI ECU 113, a DSP 114, and speakers 12-1 to 12-3. The CORE ECU 111, the IVI ECU 113, and the DSP 114 are computers that include a processor as a processing circuit such as a central processing unit (CPU) or a micro processing unit (MPU). The functions of each unit are realized when a prescribed program is executed by the processing circuits.

The CORE ECU 111 is an ECU (electronic control unit) that controls operations of the entire in-vehicle system 101. For example, the CORE ECU 111 controls the motors 112-1 and 112-2 according to driving operations by the driver. In addition, the CORE ECU 111 controls travel according to an action plan created by a driving automation system.

THE IVI ECU 113 is an ECU for IVI (in-vehicle infotainment). The IVI ECU 113 controls input of instructions by the driver and presentation of various kinds of information to the driver. The IVI ECU 113 controls display on a display provided in front of the driver's seat or the like.

The DSP 114 controls output of sound from speakers provided inside and outside of the vehicle. Voice guidance for the driver, alert sounds, music, and the like are output from the speakers. The DSP 114 outputs the pseudo powertrain sound from the speakers 12-1 to 12-3. While three speakers are shown in the present example, more speakers are additionally provided inside and outside of the vehicle 1. At least one of the speakers provided outside of the vehicle and the speakers provided inside the vehicle is used to output the pseudo powertrain sound.

The DSP 114 includes a memory 114A. The memory 114A stores a program that realizes output control of the pseudo powertrain sound. The memory 114A includes a function as a program storage medium. The memory 114A stores various kinds of data such as audio data of the pseudo powertrain sound.

The in-vehicle system 101 is provided with other components such as the driving automation system that realizes driving automation functions. For example, processing related to the driving automation functions includes processing of recognizing a situation of the vehicle 1 and surroundings based on measurement results by sensors including a camera and processing of generating map information and estimating the vehicle's own position based on measurement results by the sensors. In addition, processing related to the driving automation functions includes processing of creating a travel plan from start to goal using map information or the like and processing of controlling operations of the vehicle 1 in order to realize the travel plan.

In addition, a component such as a TCU (telematics control unit) that communicates with an external server is provided. 5G communication (5th generation mobile communication system), LTE (Long Term Evolution), wireless LAN, or the like is used to communicate with the external server. For example, programs transmitted from the server are received by the TCU and supplied to each unit. The programs received by the TCU include a program that realizes output control of the pseudo powertrain sound.

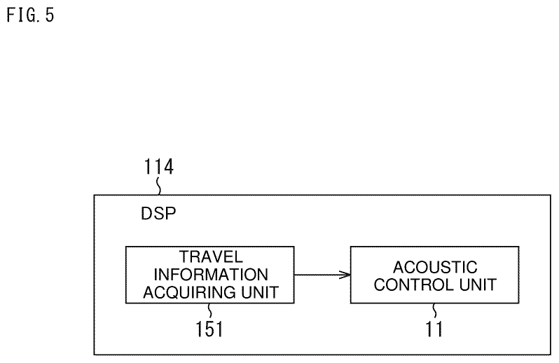

FIG. 5 is a block diagram showing a functional configuration example of the in-vehicle system 101. FIG. 5 shows a configuration related to output control of the pseudo powertrain sound.

The DSP 114 includes a travel information acquiring unit 151 in addition to the acoustic control unit 11 configured as described with reference to FIG. 2. For example, in the DSP 114, the travel information acquiring unit 151 and the acoustic control unit 11 are realized when a program stored in the memory 114A is executed.

The travel information acquiring unit 151 acquires travel information generated based on a measurement result by the sensors and the like. Travel information indicating a travel state of the vehicle 1 is generated by the CORE ECU 111 and the like to be used in processing of the various units. Travel information to be used in the processing of the various units is supplied to the DSP 114 and acquired by the travel information acquiring unit 151.

A motor torque, an accelerator position, a velocity, and the like during deceleration and acceleration are represented by the travel information acquired by the travel information acquiring unit 151. The travel information acquired by the travel information acquiring unit 151 is supplied to the acoustic control unit 11.

The acoustic control unit 11 controls, based on information supplied from each unit, output of the pseudo powertrain sound to be outputted in the vehicle. For example, the acoustic control unit 11 reproduces audio data of each sound constituting the pseudo powertrain sound, outputs an audio signal of the reproduced sound to each speaker, and causes the speaker to output the pseudo powertrain sound.

The acoustic control unit 11 controls output of the pseudo powertrain sound as described above during acceleration and deceleration. The acoustic control unit 11 causes output of the low-frequency sound part and the high-frequency sound part which are a plurality of types of sound with different frequency ranges to be started at respectively different timings according to changes in the travel state.

### Operation of In-Vehicle System

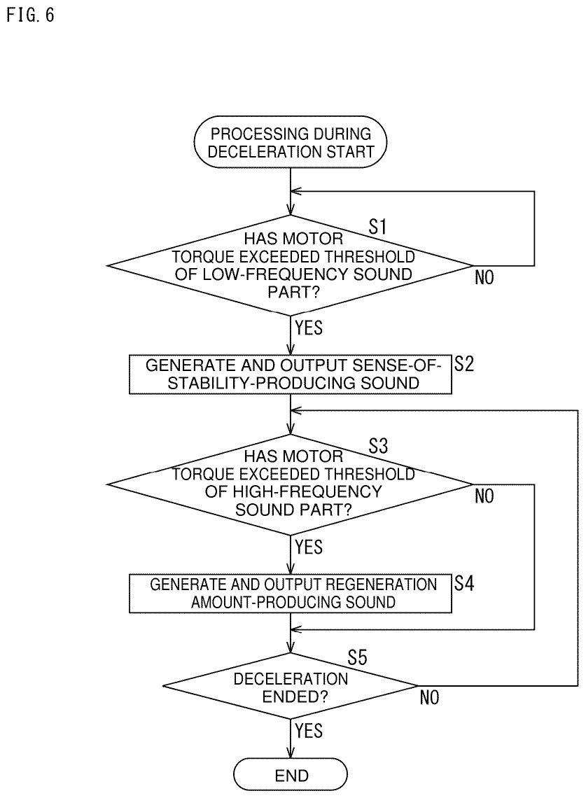

FIG. 6 is a flow chart showing an example of processing during deceleration of the in-vehicle system 101.

In step S1, the acoustic control unit 11 determines whether or not the motor torque during deceleration has exceeded the threshold for the low-frequency sound part and stands by until it is determined that the threshold has been exceeded. A minute motor torque is set as the threshold for the low-frequency sound part.

When it is determined in step S1 that the motor torque during deceleration has exceeded the threshold for the low-frequency sound part, in step S2, the sense-of-stability-producing sound generating unit 21 (FIG. 2) of the acoustic control unit 11 generates a sense-of-stability-producing sound and outputs the sense-of-stability-producing sound at a volume according to the motor torque. The sense-of-stability-producing sound generating unit 21 continues to output the sense-of-stability-producing sound while changing the pitch according to the motor torque.

In step S3, the acoustic control unit 11 determines whether or not the motor torque during deceleration has exceeded the threshold for the high-frequency sound part. A motor torque that is higher than the threshold for the low-frequency sound part is set as the threshold for the high-frequency sound part.

When it is determined in step S3 that the motor torque during deceleration has exceeded the threshold for the high-frequency sound part, in step S4, the regeneration amount-producing sound generating unit 22 of the acoustic control unit 11 generates a regeneration amount-producing sound and outputs the regeneration amount-producing sound at a volume according to the motor torque. The regeneration amount-producing sound generating unit 22 continues to output the regeneration amount-producing sound while changing the pitch according to the motor torque. When it is determined in step S3 that the motor torque during deceleration has not exceeded the threshold for the high-frequency sound part, the processing of step S4 is skipped.

In step S5, the acoustic control unit 11 determines whether or not deceleration has ended. Processing of step S3 and subsequent steps is repeatedly performed until it is determined that deceleration has ended.

### Modifications

Although it has been described that the output control of the pseudo powertrain sound is performed according to a motor torque, an accelerator position, and a velocity, the output control can be performed according to other travel states regarding the vehicle 1. Examples of travel states that can be used for the output control of the pseudo powertrain sound include an acceleration in the front-rear direction (forward G/backward G) and an acceleration in the lateral direction (lateral G) that occurs in the vehicle during driving. Note that the acceleration in this case refers to acceleration with respect to the standard acceleration of gravity.

In this case, the travel information acquired by the travel information acquiring unit 151 includes information regarding an acceleration calculated by the CORE ECU 111 or the like based on measurement results of the sensors. The acoustic control unit 11 controls the output of the pseudo powertrain sound as described above according to the acceleration represented by the travel information acquired by the travel information acquiring unit 151.

As described above, the travel information includes information indicating at least any of a torque of the motors that control drive of the vehicle, an acceleration in the front-rear direction, an acceleration in the lateral direction, a velocity, and an accelerator position. Output control of the pseudo powertrain sound may be performed based on other travel states such as a vehicle swept path, a steering angle of the steering wheel, a depression angle of the gas pedal/brake pedal, and an acceleration.

The plurality of sounds that constitute the pseudo powertrain sound may each be outputted from a different speaker.

A device other than a speaker may be used as a device that constitutes an output unit of the pseudo powertrain sound. Examples of the device that constitutes the output unit of the pseudo powertrain sound include an exciter. In addition, when a vibration device that generates vibration is mounted on a seat, the pseudo powertrain sound may be outputted using the vibration of the vibration device.

For example, vibrations having different patterns are used as the low-frequency sound part and the high-frequency sound part that constitute the pseudo powertrain sound. Even in this case, output of the variation having the pattern to constitute the low-frequency sound part is started first in response to an occurrence of a minute change in the travel state. After the output of the vibration of the low-frequency sound part is started, output of the vibration having the pattern to constitute the high-frequency sound part is started.

The output of the pseudo powertrain sound may be realized using object-based audio. In this case, the acoustic control unit 11 is provided with a reproduction function of object-based audio that outputs a reproduced sound from any position by setting a sound source at any position in the vehicle and performing rendering processing of audio data according to the sound source position. The plurality of sounds that constitute the pseudo powertrain sound may each be outputted from a sound source set at a different position.

The series of processing described above can be executed by hardware or executed by software. When the series of processing is to be executed by software, a program constituting the software is to be installed in a computer. In this case, the term “computer” is to include computers built into dedicated hardware and general-purpose personal computers or the like that enable various functions to be executed by installing various programs.

The program to be executed by the computer (processing circuitry) can be provided recorded on a removable medium as a packaged medium or the like. In addition, the program can be provided via a wired or wireless transmission medium such as a local area network, the Internet, and digital satellite broadcast.

The program to be executed by the computer may be a program that is processed chronologically according to the order described in the present specification or a program that is processed in parallel or at necessary timing such as when a call is made.

The processing performed by the computer according to the program need not necessarily be performed chronologically according to the orders described as flowcharts. In other words, the processing that the computer performs according to the program includes processing that is executed in parallel or individually (for example, parallel processing or object-based processing).

The program may be processed by a single computer (processor) or processed in a distributed manner by a plurality of computers. Furthermore, the program may be transferred to and executed by a remote computer.

In the present specification, a system means a single component or a set of a plurality of components (apparatuses, modules (parts), and the like). Therefore, one or more components of a computer such as a processor on its own or a combination of a processor and a memory constitute a system. With respect to a set of a plurality of components, whether or not all of the components are housed in a same enclosure is irrelevant. Therefore, a plurality of apparatuses housed in separate enclosures and connected via a network, a single apparatus containing a plurality of modules in a single enclosure, and the like all constitute systems. Furthermore, for example, an entire computer or a combination of a computer and another apparatus such as a server (not illustrated) also constitute a system.

The embodiment of the present technique is not limited to the embodiment described above and various modifications are possible within the scope of the gist of the present technique.

The effects described in the present specification are illustrative only and are not limited, and there may be other effects as well.

### REFERENCE SIGNS LIST

11 acoustic control unit, 101 in-vehicle system, 114 DSP, 151 travel information acquiring unit.

1. An in-vehicle system, comprising:
an acquiring unit configured to acquire travel information indicating a travel state of a vehicle; and
an acoustic control unit configured to start output of a plurality of types of sounds with different frequency ranges that constitute a pseudo powertrain sound during acceleration and deceleration at different timings according to a change in the travel state, wherein
the plurality of types of sounds includes a first sound in a low-frequency range and a second sound in a high-frequency range higher than the low-frequency range,
the acoustic control unit is further configured to start output of the first sound upon a change in the travel state, and start output of the second sound at a timing after the output of the first sound has started, the first sound continuing while the second sound is output, and
the acquiring unit and the acoustic control unit are each implemented via at least one processor.

2. The in-vehicle system according to claim 1, wherein
the acquiring unit is further configured to acquire the travel information that indicates at least any of a torque of a motor that controls drive of the vehicle, an acceleration in a front-rear direction occurring during travel, an acceleration in a lateral direction, a velocity of the vehicle, and an accelerator position, and
the acoustic control unit is further configured to control the output of each sound that constitutes the pseudo powertrain sound based on the travel information.

3. The in-vehicle system according to claim 2, wherein
the acoustic control unit is further configured to start the output of the first sound that constitutes the pseudo powertrain sound when there is a change in the travel state of a smaller amount of change than an amount of change that defines an output timing of the second sound with a higher frequency range than the first sound.

4. The in-vehicle system according to claim 3, wherein
the acoustic control unit is further configured to start the output of the second sound at a timing later than the output timing of the first sound.

5. The in-vehicle system according to claim 3, wherein
the acoustic control unit is further configured to change a pitch of the second sound to a larger degree than a change in a pitch of the first sound according to the travel state.

6. The in-vehicle system according to claim 1, wherein
the acoustic control unit is further configured to output the pseudo powertrain sound from at least any of a speaker or an exciter provided inside the vehicle or outside the vehicle.

7. The in-vehicle system according to claim 1, wherein
the acoustic control unit is further configured to control drive of a vibration device provided inside the vehicle and generate a vibration according to the pseudo powertrain sound.

8. The in-vehicle system according to claim 3, wherein
the first sound and the second sound are sounds separated from each other by two or more octaves.

9. A non-transitory computer-readable medium having embodied thereon a program, which when executed by a computer causes the computer to execute a processing method, the method comprising:
acquiring travel information indicating a travel state of a vehicle; and
starting output of a plurality of types of sounds with different frequency ranges that constitute a pseudo powertrain sound during acceleration and deceleration at different timings according to a change in the travel state, wherein
the plurality of types of sounds includes a first sound in a low-frequency range and a second sound in a high-frequency range higher than the low-frequency range, and
the starting output of the plurality of types of sounds includes starting output of the first sound upon a change in the travel state, and starting output of the second sound at a timing after the output of the first sound has started, the first sound continuing while the second sound is output.

10. A processing method, the method comprising:
acquiring travel information indicating a travel state of a vehicle; and
starting output of a plurality of types of sounds with different frequency ranges that constitute a pseudo powertrain sound during acceleration and deceleration at different timings according to a change in the travel state, wherein
the plurality of types of sounds includes a first sound in a low-frequency range and a second sound in a high-frequency range higher than the low-frequency range, and
the starting output of the plurality of types of sounds includes starting output of the first sound upon a change in the travel state, and starting output of the second sound at a timing after the output of the first sound has started, the first sound continuing while the second sound is output.
